(19) United States
(12) Patent Application Publication
(10) Pub. No.: US 2003/0217306 A1
(43) Pub. Date: Nov. 20, 2003

(54) Self-programmable microcomputer and method of remotely programming same

(76) Inventors: Jerry D. Harthcock, Plano, TX (US); Peter Koenig, Plano, TX (US)

Correspondence Address: Steven W. Smith, Attorney at Law, Suite 120, 840 Central Parkway East, Plano, TX, 75074, US

(21) Appl. No.: 10/198,807

(22) Filed: Jul. 19, 2002

Related U.S. Application Data
(60) Provisional application No. 60/381,670, filed on May 17, 2002.

(51) Int. Cl. H04L 1/22

(52) U.S. Cl. 714/30

(57) ABSTRACT

A user-configurable and/or self-configurable System on a Chip (SoC) device and corresponding remote programming method enabling the SoC to be reprogrammed multiple times from a remote chip file server. Once programmed with the desired SoC design, the device can be debugged remotely in real-time by one or more users. The device includes a helper microcontroller/programmer, and a Field Programmable Gate Array (FPGA) fabric which is divided into a plurality of programmable logic and clock driver domains that may be independently programmed by way of the helper microcontroller. Once programmed, the helper microcontroller can serve as a real-time monitor/data exchange sub-controller and/or may be used by the end application.

### PRIORITY STATEMENT UNDER 35 U.S.C. §119(e) & 37 C.F.R. §1.78

This nonprovisional application claims priority based upon the prior U.S. provisional patent application entitled, “Self-Deliverable Microcontroller/SoC and IP Delivery System and Method”, application No. 60/381,670, filed May 17, 2002 in the name of Jerry D. Harthcock.

### BACKGROUND OF THE INVENTION

1. Technical Field of the Invention

This invention relates to microcomputer architectures. More particularly, and not by way of limitation, the present invention is directed to a self-programmable microcomputer and method of remotely programming the microcomputer.

2. Description of Related Art

Most modern appliances, instruments, entertainment electronics, computers, automobiles, data storage devices, aircraft, weapons, pagers, telephones, and so on have embedded within the product one or more microprocessors, microcontrollers, Reduced Instruction Set Computers (RISCS), and/or Digital Signal Processors (DSPs). Today, most of these embedded microcontrollers/DSP(s) are embedded in an Application Specific Integrated Circuit (ASIC) which comprises not only the microcontroller/DSP(s) but also the other circuitry specific to an intended application. The current popular term for this configuration is a System on a Chip (SoC).

There are basically two existing methodologies for bringing a SoC into existence. The first involves (1) acquiring the required functional design, usually in the form of a synthesizable Verilog or a Very High Speed Integrated Circuit (VHSIC) Hardware Description Language (VHDL) netlist or source, by way of a license or through in-house/contract development, (2) combining the functional design into the SoC product design, (3) simulating and testing the design, (4) “taping-out” into a design file, and (5) submitting the design file to a target foundry. The foundry, in turn, sends the design file to a mask shop which produces the masks needed by the foundry for manufacturing the SoC ASIC. Overall, this method is an extremely time consuming, very expensive, and somewhat risky flow. Therefore, a large order commitment is necessary prior to beginning the development of a SoC using this method.

The second methodology usually involves the same initial steps, but a Field Programmable Gate Array (FPGA) is used in large part for most of the later steps of producing the SoC. FPGAs are manufactured blank, as an array of open gates, and may have some embedded RAM blocks or specialized Input/Output (I/O) function blocks. The user then programs the FPGA by selectively closing gates to create hardware logic circuits. Today, FPGAs are programmed in one of two ways. First and most conventionally, the FPGA is inserted into a fixture where a special external programmer is used to program it. The external programmer has address lines, data lines, and lines that apply programming voltages to the FPGA gates. Conventional FPGAs utilize what is known as anti-fuse technology in which voltages above a threshold level are selectively applied to particular gates in order to fuse them and create the logic circuit. Once the FPGA is programmed, it is then taken out of the programmer and inserted into the user's circuit. For example, the FPGA may be soldered directly onto a printed circuit board (PCB), or may be inserted into a special FPGA socket mounted on the PCB.

Anti-fuse FPGAs can only be programmed once. If a mistake is made in the implemented design, or if a new updated design is developed, the programmed FPGA must be removed from the user's circuit and discarded. A new FPGA must then be programmed using the external programmer and fixture, and substituted in the user's circuit. It is expensive to de-solder a part and remove it from a PCB. Usually, the whole PCB including the expensive FPGA socket has to be discarded.

More recently, reprogrammable FPGAs have been developed utilizing either SRAM or FLASH technology. SRAM-based FPGAs may be programmed on power-up from an external configuration memory (parallel or serial) such as an EEPROM/FLASH device. FLASH-based FPGAs may be programmed initially in a fixture using an external programmer. The programmer utilizes an IEEE 1149.1 Joint Test Access Group (JTAG) connection to scan programming instructions into the FPGA and program the logic elements. Once the FPGA is programmed, it is then taken out of the programmer and is mounted on the user's PCB. Thereafter, a special programmer may be utilized to reprogram the FLASH-based FPGA on the user's PCB.

In many cases, some of the functional design is already embedded as hard macros in the FPGA fabric itself. These macros may include a complete microcontroller, RAM blocks, multipliers, adders, and so on. This method bypasses the steps of finding a foundry, taping out, performing the initial non-recurring engineering, and obtaining a large order commitment, thereby shortening the time to market.

On a larger scale, users have additional barriers that they must overcome in order to get a microcomputer product to market. Currently, the user must determine: (1) what microcomputer design is most appropriate for his needs, (2) how can he get a license for the selected microcomputer design, (3) whom does he get the license from, (4) once the license is obtained, how does the user use it to get the design onto silicon, and (5) how does the user actually get the programmed silicon into his own hands. The user must have some kind of target device and must go through the process of designing the device in which the microcomputer design is going to be implemented. Thus, there are currently a lot of barriers to overcome, and each barrier costs the user time and money.

The aforementioned methodologies of producing a SoC and getting the SoC to market have disadvantages in terms of efficiency of SoC development, reconfigurability, IP (i.e. microcomputer design) acquisition/licensing, and cost. Time to market is critical in SoC development due, in part, to the fact that SoCs traditionally have had short product/market life due to obsolescence. However, if the SoC can be readily reprogrammed (re-implemented) with newer design files (as well as new application software) the life of the product can theoretically be extended indefinitely.

In order to overcome the disadvantage of existing solutions, it would be advantageous to have a self-programmable FPGA microcomputer and a method of remotely programming the microcomputer that enables the user to program the microcomputer without requiring an external programmer and fixture. This would enable the user to program the FPGA while it is mounted on the user's application PCB. It would be additionally advantageous if the FPGA was reprogrammable, and the if the design file required to program the FPGA was readily available for licensing and downloading over the Internet. The present invention provides such a microcomputer and method.

### SUMMARY OF THE INVENTION

In one aspect, the present invention is directed to a user-configurable and/or self-configurable SoC device and corresponding method that can be reprogrammed multiple times from a remote chip file server. Once programmed with the desired SoC design, the device can be debugged remotely in real-time by one or more users. The device comprises a helper microcontroller/programmer, and an FPGA fabric which is divided into a plurality of programmable logic and clock driver domains that may be independently programmed by way of the on-chip, hard logic, programmer/controller means. Once programmed, the helper microcontroller can serve as a real-time monitor/data exchange sub-controller and/or may be used by the end application.

In another aspect, the present invention is directed to a self-programmable microcomputer comprising a helper microcontroller, a programmable central processing unit (CPU) device electronically connected to the helper microcontroller, and an interface between the helper microcontroller and the CPU device for conveying programming instructions from the microcontroller to the CPU device. The programming instructions may be resident on the microcontroller, or may be downloaded over a data network from a remote server, PC, or web site.

In yet another aspect, the present invention is directed to a microcomputer programming system. The system includes at least one domain of Field Programmable Gate Array (FPGA) fabric, a helper microcontroller electronically connected to the FPGA fabric domain, and an interface between the helper microcontroller and the FPGA fabric domain that conveys programming instructions from the microcontroller to the FPGA fabric domain. The system may also include a database accessible over a data network via an external interface. The database may include instructions for programming at least one microcomputer design in the FPGA fabric domain, and means for a user to select a microcomputer design for downloading. The database may also include a plurality of functional software blocks for programming microcomputer functions in the FPGA fabric domain, and means for a user to select for downloading, a plurality of functional blocks which, together, form a microcomputer design.

In yet another aspect, the present invention is directed to a method of programming a microcomputer comprising the steps of electronically connecting a helper microcontroller to a programmable CPU device, and conveying programming instructions from the helper microcontroller to the CPU device. The CPU device may include a plurality of independently programmable FPGA fabric domains, and programming instructions may be conveyed to a first FPGA fabric domain while leaving the remaining domains unprogrammed. The method may also include determining whether the programming of the CPU device needs to be changed, and if so, conveying programming instructions to a second FPGA fabric domain and deactivating the first FPGA domain.

The method may also include providing an external interface between the helper microcontroller and a server having a database of microcomputer programming instructions; selecting a set of desired programming instructions utilizing the external interface; and downloading the selected set of instructions via the external interface from the server to the helper microcontroller for programming the CPU device. The helper microcontroller may send a device-unique identification code to the server for authentication and a license validity check. If a license is required for the selected set of programming instructions, and the user does not have a valid license, the user is given the immediate opportunity to obtain the license. If the user accepts the license, the method proceeds to download the selected set of instructions. If the user does not accept the license, the user is provided with an opportunity to select a different set of instructions.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a first embodiment of the microcomputer of the present invention in which a single FPGA fabric domain is implemented;

FIG. 2 is a simplified block diagram of a second embodiment of the microcomputer of the present invention in which a plurality of FPGA fabric domains are implemented;

FIG. 3 is a simplified block diagram of a third embodiment of the microcomputer of the present invention in which the components of the microcomputer are implemented separately; and

FIG. 4 is a flow chart illustrating the steps of the preferred embodiment of the method of the present invention.

### DETAILED DESCRIPTION OF EMBODIMENTS

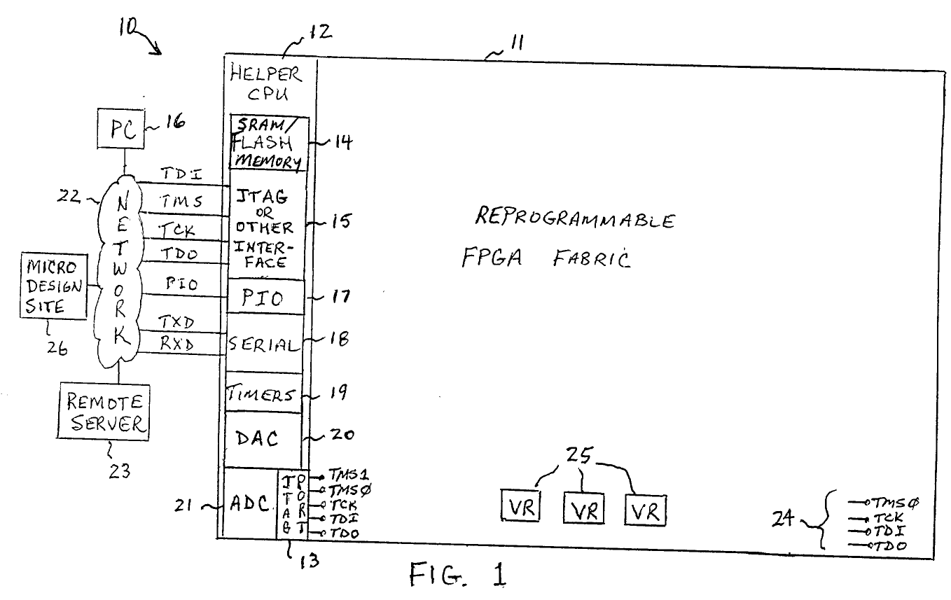

FIG. 1 is a simplified block diagram of a first embodiment of the microcomputer 10 of the present invention. The microcomputer includes one or more FPGA fabric domains 11 for implementing one or more main CPUs. A “helper” microcontroller/programmer 12 is connected to the FPGA fabric through an IEEE 1149.1 JTAG port 13. The FPGA fabric has programmable logic cells and may additionally have hard macros such as multipliers, counters, serial ports/shifters, adders, and the like embedded therein. The FPGA fabric may also include one or more hard microcontroller CPUs and/or an array of microcontroller CPUs, and may include embedded RAM blocks which can be used by the downloaded main CPU as program/data memory.

The helper microcontroller may be any type of microcontroller (9-bit for example), and may be implemented on the same chip with the FPGA fabric, or may be implemented separately. The helper microcontroller's software/firmware may be reprogrammable. The helper microcontroller includes a memory 14 which may comprise up to 256K×16 Static Random Access Memory (SRAM) and 1M×16 FLASH memory for program and data storage. The helper microcontroller may also include a JTAG (or other) slave interface 15 for sending and receiving JTAG signals to a Personal Computer (PC) 16 or another microcomputer. The helper microcontroller may also include a Parallel I/O (PIO) 17, a serial port 18 such as an RS232-compatible port, at least one timer 19 which supplies the main CPU with its clock, a digital-to-analog converter (DAC) 20, and an analog-to-digital converter (ADC) 21. The serial port and other I/O signal pins may be connected through a network 22 such as the Internet to the PC 16 or to a remote server 23. The link to the remote server may be any suitable data interface, and may for example, be a wireline or wireless' interface. The wireless interface may be any suitable technology such as Radio Frequency (RF), Infrared (IR), or electromechanical or acoustic transceiver/ transducer.

The microcontroller can itself become a JTAG master. The JTAG port 13 is a hardware connection point that enables an auto-router to connect through the helper microcontroller to program the FPGA fabric. The FPGA domain also includes virtual JTAG Real Time Monitor (RTM) tie-on points 24. Thus, through the JTAG connection, the user can communicate with the microcontroller(s), operate it, debug it, and so on, and can enter the scan chain and communicate with, or reprogram a virtual or soft core that may be implemented in the FPGA fabric.

In one embodiment, the helper microcontroller 12 downloads a chip file from an external source such as a PC through the RS232 serial port 18, and converts the signal to the JTAG protocol to abide by the protocol for programming the FPGA 11. The helper microcontroller then programs the FPGA fabric through the JTAG port 13. A blank FPGA may be merged with a helper microcontroller on the same piece of silicon. Then, instead of having an external programmer requiring a special fixture, the programmer is embedded in the chip itself. Once the main CPU soft core is loaded/programmed into the FPGA fabric by the helper microcontroller, the helper is used as an interface between the PC and the target CPU for real-time monitoring and debug of one or more of the domains (CPUs) just programmed.

Data collected by the helper microcontroller 12 from its (or someone else's) serial ports, timer/counters, ADC, DAC, and the like may be “pushed” periodically into special regions of the main CPU soft core's memory space which have been designated for that purpose. These regions are called virtual control/status registers or VRs 25 for short. The microcontroller includes all the functionality desirable on a SoC, and an efficient way for the programmed fabric CPUs to take advantage of these resources is for the helper microcontroller to push the contents of these functions into the VRs that have been predesignated in these applications. In addition, data, application programs, and pre-designed or user-designed microcomputer designs may be downloaded from an Internet web site 26 and pushed into the FPGA 11. The “pushing” is done intelligently by way of (1) the on-chip/onboard helper microcontroller 12, (2) by use of the JTAG port 13, and/or (3) by way of a cascade instruction pipeline as described in co-pending and co-owned U.S. patent application Ser. No. 10/144,524 entitled “Cascaded Microcomputer Array and Method,” which is hereby incorporated by reference herein in its entirety. The helper microcontroller 12 may also “pop” data out of the main CPU 11 and/or other embedded microcontroller cores which may be hard or soft cores.

As an example to the “push” and “pop” functionality, the helper microcontroller 12 can push various functions into the implemented microcomputer (IM) from the helper microcontroller's SRAM/FLASH memory 14. FPGAs do not currently offer embedded “non-volatile” memory blocks. The helper microcontroller has extra unused memory which can be partitioned off for the IM. The helper microcontroller functions as a storage device that can (1) receive application programs for itself and the IM via the Internet or other source and store the programs in its local FLASH memory, and (2) on power up, push the IM's application program into the IM's program memory space (using the real-time monitor technology). Once the IM is running, a protocol can be established using virtual registers and flags that allows the IM to access the helper microcontroller's FLASH memory as if it were a storage device (serial access). This eliminates the need to have an extra external memory from which the IM can boot on power up.

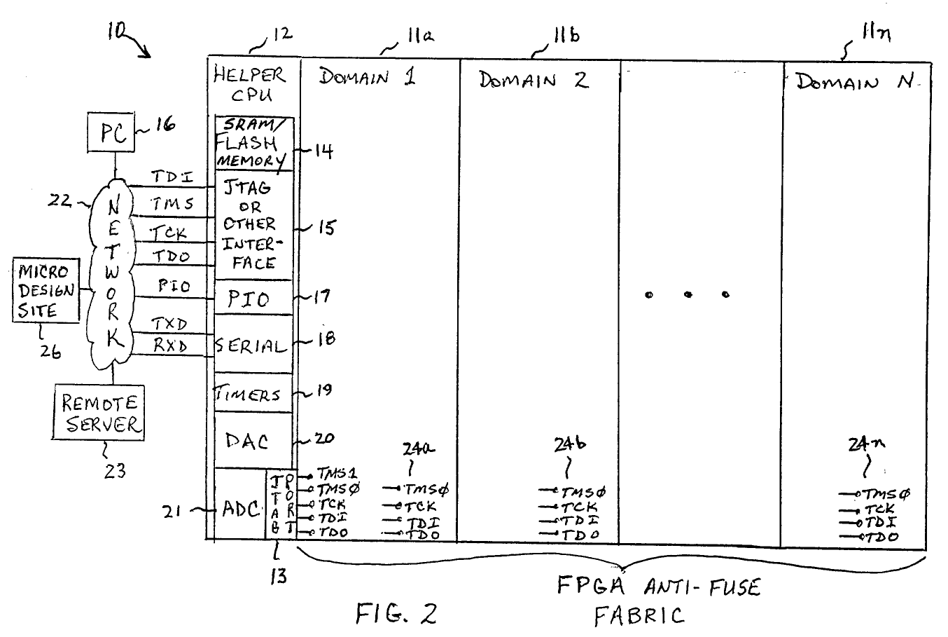

FIG. 2 is a simplified block diagram of a second embodiment of the microcomputer of the present invention in which the FPGA fabric is divided into a plurality of independent domains 11a-11n. A different main CPU may be programmed into each FPGA domain, and may utilize the same set of I/O pins. Each FPGA domain also includes virtual JTAG RTM tie-on points 24a-24n, enabling all of the multiple main CPUs to be debugged and monitored in real-time by way of the helper microcontroller and the RTM architecture. In FIG. 2, the FPGA fabric is shown as being anti-fuse fabric although in practice, the FPGA fabric may be anti-fuse or reprogrammable logic elements. When utilizing anti-fuse fabric, the user would ordinarily not be able to reprogram an FPGA device, or correct a programming mistake. With the present invention, however, after the first domain 11a is programmed, if the developer determines that there are mistakes in the design implementation or programming, or if an updated version of the design is developed, the second domain lib can be independently programmed. The first domain may then be deactivated. Thus, the developer is provided with “insurance” because if a mistake is made in the initial programming, the developer gets at least one more shot at getting it right, without having to de-solder and remove the offending FPGA and possibly an expensive socket.

In this embodiment, the invention can once again reconfigure itself automatically and periodically by downloading ready-made and matching application program files as well as a plurality of FPGA fabric domain files from the remote server 23. The present invention also provides the user with the ability to update the programming in the future without removing the FPGA from the PCB or having to purchase another FPGA. This can be of critical importance if the device is in an inaccessible location. For example, the device may be in a spacecraft on an inter-planetary mission, or may be embedded in a medical device implanted in the human body.

Even if the FPGA fabric 11 is reprogrammable (for example, SRAM or FLASH based), the FPGA fabric may still be programmed in multiple domains. Each domain may be programmed as a different processor or other special function block. The helper microcontroller 12 then pushes its resources into any one or any combination of the domains. For example, one domain may be programmed as a nucleus processor while the others are programmed as proto-processors. The concept of nucleus and proto-processors is described in detail in co-pending and co-owned U.S. patent application Ser. No. 10/144,524 referred to above. In such an arrangement, the proto-processors may operate independently, or may be joined with the nucleus processor whenever a cascaded instruction instructs them to do so.

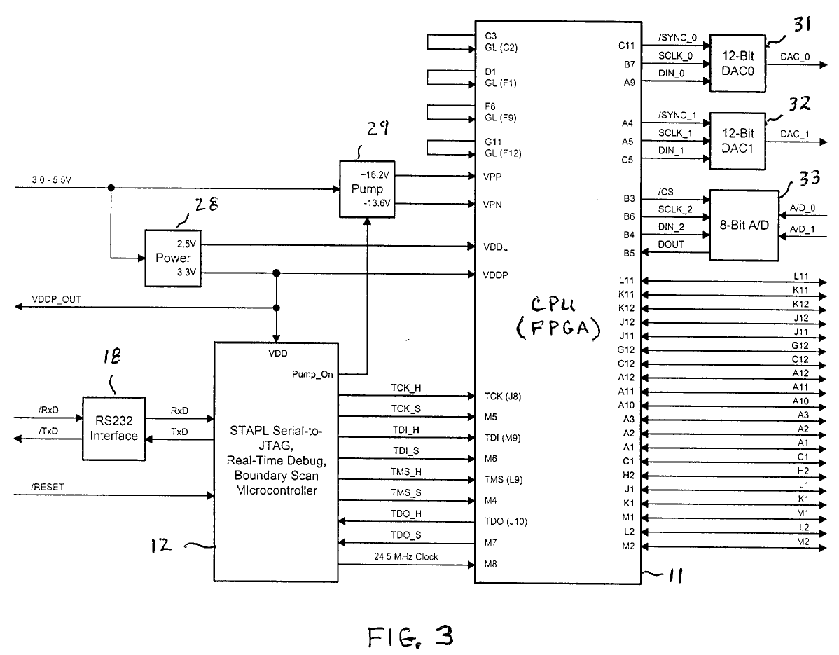

FIG. 3 is a simplified block diagram of a third embodiment of the microcomputer of the present invention in which the components of the microcomputer are implemented separately. The helper microcontroller 12 may be utilized for programming and real-time debugging and monitoring of the main CPU 11, and can perform IEEE 1149.1 JTAG boundary scan (SAMPLE/PRELOAD) snap shots of the FPGA pins while the CPU is running. As with other embodiments, the microcomputer also provides a built-in, JTAG-accessible, real-time debug and monitoring interface in the helper microcontroller. Once programmed with the desired SoC design, the CPU can be debugged remotely in real-time through the helper microcontroller by one or more users.

The helper microcontroller 12 is illustrated as using a Standard Test and Programming Language (STAPL) file to program the main CPU 11. The serial RS232-compatible interface 18 is shown as the primary interface for providing this file to the helper microcontroller. Normally, the PC 16 (FIG. 1) interprets the STAPL file and sends programming commands to the helper microcontroller via the RS232 interface. Also illustrated are a power supply 28, and a charge pump 29 which increases the voltage from the power supply from an operating range to a programming range. The operating range of approximately 2.5 Volts Drain-Drain Logic (VDDL) to 3.3 Volts Drain-Drain Peripherals (VDDP) is applied to a first set of pins while the programming range of approximately −13.6 Volts Programming Negative (VPN) to +16.2 Volts Programming Positive (VPP) is applied to a second set of pins. The configuration also provides two 12-bit serial DACs 31 and 32, and one 8-bit, 2-channel serial ADC 33. The DACs take their reference from the 3.3 volt VDDP supply for the widest possible dynamic output range, and can clock at speeds up to 30 MHz. The DACs output impedances are programmable and tri-stateable.

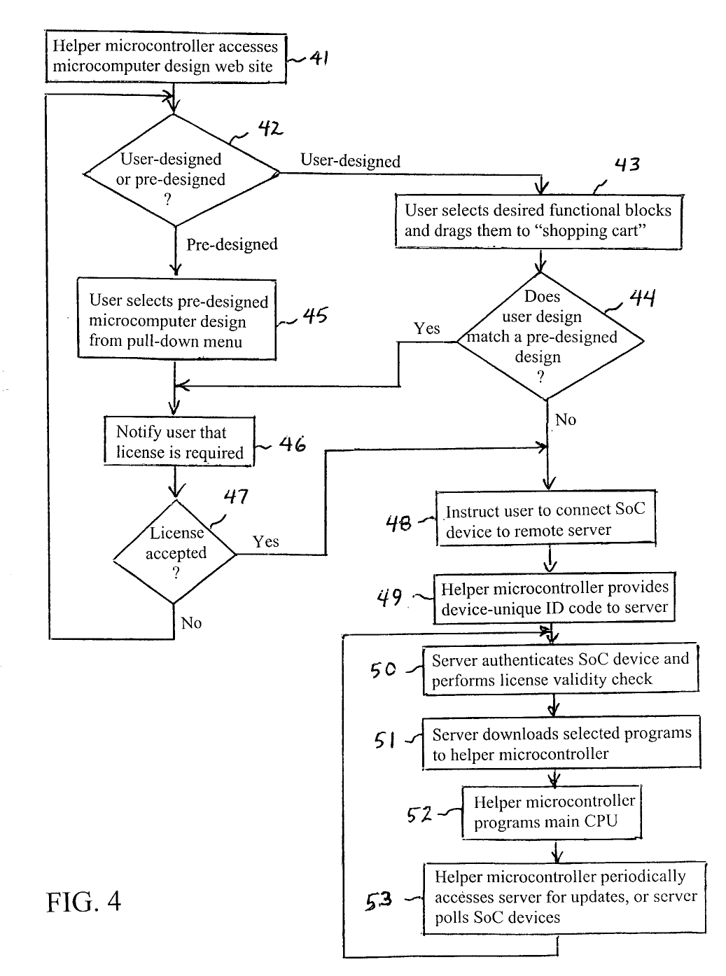

FIG. 4 is a flow chart illustrating the steps of the preferred embodiment of the method of the present invention. The invention provides an efficient Internet process for users to obtain needed microcomputer designs and application programs to program the microcomputer of the present invention. As noted above, currently, the user must overcome a number of barriers in order to obtain a programmed, functional, and embedded FPGA processor. First, the user must determine what microcomputer design is most appropriate for his needs. At step 41, the present invention accesses the Internet web site 26 having a menu of pre-designed microcomputers, filters, controllers, and other functional blocks. At step 42, it is determined whether the user desires to design his own microcomputer or utilize a pre-designed microcomputer. If the user desires to build his own microcomputer, the method moves to step 43 where the user may select desired functional blocks and drag them to a “shopping cart”. At step 44, it is determined whether the user has built a design that matches a pre-designed design. If so, the method moves to step 46 where the user is notified that a license is required for the microcomputer design, and is given the opportunity to obtain a license at that time.

If, however, at step 42 the user desires to utilize a pre-designed microcomputer, the method moves to step 45 where the user may select a design by, for example, pulling down a drop-down menu. The method then moves to step 46, where once again the user is notified that a license is required for the microcomputer design, and is given the opportunity to obtain a license at that time. At step 47, it is determined whether or not the user accepts the license. If not, the method returns to step 42 where the user is given the opportunity to obtain or design a different microcomputer.

If the user accepts the license at step 47, or, if at step 44 it was determined that the user did not design a pre-designed microcomputer design, the method moves to step 48 where the user is given instructions to connect his blank user-configurable and/or self-configurable SoC device to the remote server 23 on which the program for the selected design resides. At step 49, the helper microcontroller 12 on the user's device provides a device-unique ID code to the server. The ID code is unique for each particular device, and thus, is not the same as a JTAG ID code. The JTAG ID code is not unique for a particular individual device, but is the same for all devices of a particular part number. The device-unique ID code in the present invention provides unique identifying information to the remote server. At step 50, the server may authenticate the device and perform a license validity check.

Once the authentication and validity check is complete, the moves to step 51 where the program(s) are downloaded to the helper microcontroller 12. At step 52, the helper microcontroller then programs the main CPU in the FPGA fabric 11. In this way, the user instantly gets his selected design onto silicon, and gets the programmed silicon into his own hands. Thus, the present invention eliminates as many barriers as possible in the process of getting programmed silicon into the user's hands.

At step 53, it is illustrated that, the helper microcontroller 12 may periodically (or upon the occurrence of a specified event or sequence of events or conditions) access the remote server 23 to obtain any programming updates. The helper microcontroller 12 can go out and prompt the server 23 to check the SoC device's configuration and provide an update to its architecture if needed. Alternatively, the remote server may periodically poll a number of remote SoC devices 10 to determine whether they need to be updated. The method may then return to step 50 where the server may check the ID code of the helper microcontroller and determine whether the user's license is valid and current. If so, the programming update is downloaded to the helper microcontroller at step 51 which then reprograms the FPGA fabric 11 at step 52. Thus, the SoC device 10 can reconfigure itself automatically and periodically. Alternatively, a number of devices can be loaded/programmed simultaneously through a “broadcast” from the server. This programming may be performed over the Internet 22 to all devices with a valid ID code and address (for example a TCP/IP address) which enables the devices to be uniquely addressed. The programming may be conducted over a wireless interface such as Blue Tooth.

The helper microcontroller 12 also has to be programmed. The developer can program it himself, or can download from the server 23, ready-made and matching application program files that may be bundled with it as part of the feature set.

It should be noted that the helper microcontroller 12 can run test programs that are not limited to boundary scan which checks the pins. The helper microcontroller can run elaborate diagnostics on the system just downloaded or at any time. Not only can the FPGA design be downloaded using the helper microcontroller, but the helper itself can be reprogrammed entirely or partially with a diagnostics program from the same or a different web site. Indeed, the downloaded design can itself be a test system such as a logic analyzer which can perform tests including timing and analysis functions. At that point, the test system's logic function can be reprogrammed back into an original intended application such as a controller. The same user interface is utilized for programming, debug, boundary scan, and diagnostic testing of the downloaded system.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A self-programmable microcomputer comprising:
a helper microcontroller;
a programmable logic device electronically connected to the helper microcontroller; and
an interface between the helper microcontroller and the logic device for conveying programming instructions from the microcontroller to the logic device.

2. The self-programmable microcomputer of claim 1 wherein the logic device is a reprogrammable Field Programmable Gate Array (FPGA).

3. The self-programmable microcomputer of claim 1 wherein the logic device is an anti-fuse Field Programmable Gate Array (FPGA), said FPGA comprising a plurality of independently programmable and independently operable FPGA domains.

4. The self-programmable microcomputer of claim 3 wherein the interface between the microcontroller and the logic device includes means for programming a first FPGA domain while the remainder of the plurality of independently programmable FPGA domains remain unprogrammed.

5. The self-programmable microcomputer of claim 4 wherein the interface between the microcontroller and the logic device also includes means for programming a second FPGA domain and deactivating the previously programmed first FPGA domain.

6. The self-programmable microcomputer of claim 3 wherein the interface between the microcontroller and the logic device includes means for programming each of the plurality of FPGA domains to simultaneously perform a different function.

7. The self-programmable microcomputer of claim 1 wherein the helper microcontroller includes a memory for storing the programming instructions.

8. The self-programmable microcomputer of claim 1 wherein the helper microcontroller includes an external interface for receiving the programming instructions from an external source.

9. The self-programmable microcomputer of claim 1 wherein the interface between the microcontroller and the logic device is an IEEE 1149.1 Joint Test Access Group (JTAG) port.

10. The self-programmable microcomputer of claim 1 wherein the helper microcontroller includes means for performing IEEE 1149.1 Joint Test Access Group (JTAG) boundary scans of the logic device while the logic device is operating.

11. The self-programmable microcomputer of claim 10 wherein the helper microcontroller also includes means for debugging and monitoring the logic device in real time while the logic device is operating.

12. A microcomputer programming system comprising:
at least one domain of Field Programmable Gate Array (FPGA) fabric;
a helper microcontroller electronically connected to the FPGA fabric domain; and
an interface between the helper microcontroller and the FPGA fabric domain, said interface conveying programming instructions from the microcontroller to the FPGA fabric domain.

13. The microcomputer programming system of claim 12 further comprising:
a computer that stores programming instructions for the FPGA fabric domain; and
an external interface from the helper microcontroller to the computer, said external interface downloading the programming instructions from the computer.

14. The microcomputer programming system of claim 13 wherein the external interface is a RS232-compatible interface, and the computer includes means for interpreting a Standard Test and Programming Language (STAPL) file, and sending the interpreted STAPL file to the helper microcontroller via the RS232-compatible interface for programming the FPGA fabric domain.

15. The microcomputer programming system of claim 12 further comprising:
a database accessible over a data network, said database including:
instructions for programming at least one microcomputer design in the FPGA fabric domain; and
means for a user to select a microcomputer design for downloading; and
an external interface from the helper microcontroller to the data network and the database, said external interface downloading the programming instructions for the selected microcomputer design from the database to the helper microcontroller.

16. The microcomputer programming system of claim 15 wherein the data network is the Internet, and the database is a web site.

17. The microcomputer programming system of claim 12 further comprising:
a database accessible over a data network, said database including:
a plurality of functional software blocks for programming microcomputer functions in the FPGA fabric domain; and
means for a user to select for downloading, a plurality of functional blocks which, together, form a microcomputer design; and
an external interface from the helper microcontroller to the data network and the database, said external interface downloading the selected functional software blocks from the database to the helper microcontroller.

18. The microcomputer programming system of claim 17 wherein the data network is the Internet, and the database is a web site.

19. The microcomputer programming system of claim 12 further comprising:
a database accessible over a data network, said database including:
instructions for programming at least one microcomputer design in the FPGA fabric domain;
means for a user to select a microcomputer design for downloading;
a plurality of functional software blocks for programming microcomputer functions in the FPGA fabric domain; and
means for a user to select for downloading, a plurality of functional blocks which, together, form a microcomputer design; and
an external interface from the helper microcontroller to the data network and the database, said external interface downloading the programming instructions for the selected microcomputer design from the database to the helper microcontroller.

20. The microcomputer programming system of claim 19 further comprising a server connected to the data network and communicating with the helper microcontroller, said server including means for authenticating communications from the helper microcontroller, and for determining whether the microcontroller is licensed to received the selected microcomputer design or the selected plurality of functional software blocks.

21. The microcomputer programming system of claim 20 wherein the helper microcontroller includes means for placing a device-unique identification code in messages sent over the data network, and the means within the server for authenticating communications from the helper microcontroller includes means for authenticating the device-unique identification code.

22. The microcomputer programming system of claim 20 wherein the helper microcontroller includes means for periodically accessing the server and for requesting any updates to the programming instructions for the microcomputer.

23. The microcomputer programming system of claim 20 wherein the server includes means for periodically polling the helper microcontroller and for determining whether the microcomputer requires an update to its programming instructions.

24. The microcomputer programming system of claim 20 wherein the server includes means for broadcasting over the data network, updates to the programming instructions of a plurality of microcomputers.

25. The microcomputer programming system of claim 20 wherein the database also includes programming instructions for the helper microcontroller.

26. The microcomputer programming system of claim 12 further comprising a user interface that enables a user to program the FPGA fabric domain, debug the programmed FPGA fabric domain, run boundary scan tests of device pins, and run diagnostic testing of the programmed FPGA fabric domain utilizing the helper microcontroller and the interface between the helper microcontroller and the FPGA fabric domain.

27. A method of programming a microcomputer comprising the steps of:
electronically connecting a helper microcontroller to a programmable logic device; and
conveying programming instructions from the helper microcontroller to the logic device.

28. The method of programming a microcomputer of claim 27 wherein the logic device includes a plurality of independently programmable Field Programmable Gate Array (FPGA) fabric domains, and the step of conveying programming instructions from the helper microcontroller to the logic device includes conveying programming instructions to a first FPGA fabric domain while leaving the remaining domains unprogrammed.

29. The method of programming a microcomputer of claim 28 further comprising the steps of:
determining whether the programming of the logic device needs to be changed; and
conveying programming instructions to a second FPGA fabric domain and deactivating the first FPGA domain, when the programming of the logic device needs to be changed.

30. The method of programming a microcomputer of claim 29 further comprising the steps of:
providing an external interface between the helper microcontroller and a server having a database of microcomputer programming instructions;
selecting a set of desired programming instructions utilizing the external interface; and
downloading the selected set of instructions via the external interface from the server to the helper microcontroller for programming the logic device.

31. The method of programming a microcomputer of claim 30 further comprising, prior to the step of downloading the selected set of instructions, the steps of:
sending a device-unique identification code from the helper microcontroller to the server;
authenticating the helper microcontroller by the server utilizing the identification code;
determining by the server whether the selected set of instructions form a microcomputer design requiring a license; and
if a license is required, determining by the server whether a user of the helper microcontroller has a valid license to download the selected set of instructions.

32. The method of programming a microcomputer of claim 31 further comprising, upon determining that the helper microcontroller does not have a valid license to download the selected set of instructions, the steps of:
sending a notification from the server to the user of the helper microcontroller, said notification indicating that a license is required;
determining by the server whether the user accepts the license;
if the user accepts the license, proceeding with the step of downloading the selected set of instructions; and
if the user does not accept the license, providing the user with an opportunity to select a different set of instructions.
